(19) United States
(12) Patent Application Publication
(10) Pub. No.: US 2022/0397896 A1
(43) Pub. Date: Dec. 15, 2022

(54) VEHICLE CONTROL SYSTEM

(71) Applicant: Xingtel (Xiamen) Intelligent Control Technology Co., Ltd., Xiamen, Fujian (CN)

(72) Inventors: Jianyong YAN, Xiamen, Fujian (CN); Kai TANG, Xiamen, Fujian (CN); Kaiqi SU, Xiamen, Fujian (CN); Run YANG, Xiamen, Fujian (CN); Jianhang ZOU, Xiamen, Fujian (CN); Guangwei PAN, Xiamen, Fujian (CN); Jinyu CHEN, Xiamen, Fujian (CN)

(21) Appl. No.: 17/775,431

(22) PCT Filed: Jan. 3, 2020
(86) PCT No.: PCT/CN2020/070209

§ 371 Date: May 9, 2022

(30) Foreign Application Priority Data
Dec. 30, 2019 (CN) 201911393182.2

(51) Int. Cl. G05D 1/00; B60L 15/20; G08C 17/02

(52) U.S. Cl. CPC G05D 1/0016; B60L 15/2009; G05D 1/0022; B60L 15/2063; G08C 17/02

(57) ABSTRACT

The present disclosure relates to a control scheme for a functional motor vehicle used in a fixed site. The present disclosure provides a motor vehicle control system, including a motor vehicle and a remote-controller. The motor vehicle is provided with at least one vehicle control button. The remote-controller is provided with at least one remote-controller control button. The remote-controller and the motor vehicle can conduct a positioning and ranging. The motor vehicle control system has a first control mode and a second control mode, that is, respectively, an automatic walking mode for ensuring the safety and an easy push mode for ensuring the safety. The present disclosure can improve the vehicle control modes, allowing users to obtain better customer experience.

### TECHNICAL FIELD

The present disclosure relates to a control of functional motor vehicles used in fixed fields, and in particular, to a walking control scheme of functional motor vehicles used in such fixed fields.

### BACKGROUND

At present, functional vehicles used in fixed fields such as golf carts and tool carts on the market are controlled and run by means of remote control. However, in some complex environments and slopes in the field, it is usually difficult for the user to control the direction of the vehicle through the remote-controller. Therefore, in order to allow the user to control the vehicle more conveniently, some control buttons are usually added to the armrest part of the vehicle to push the vehicle to run through the boost mode. However, when using the boost mode, the user's hand needs to keep pressing a certain control button (for example, keep pressing the forward button). If the boost time is longer, it will inevitably cause hand fatigue, and even some users also concern that it will affect its performance on the golf course. Obviously, the user experience of the boost mode of the vehicle in the prior art is not good.

In addition, the functional vehicles used in these fixed fields are generally electric vehicles, which usually have electric brakes when they are stopped. For a vehicle in a stopped state, people cannot push it, and the vehicle must be moved forward through the control buttons on the armrest of the vehicle. But sometimes in dangerous areas or short-distance situations, if the user uses the boost button to control it, it may be dangerous.

### SUMMARY

Therefore, in the present disclosure, in order to address these problems, we propose an improved functional motor vehicle, which can improve the vehicle control mode and allow the user to obtain a better customer experience.

The present disclosure provides a motor vehicle control system, including a motor vehicle and a remote-controller; the motor vehicle being provided with at least one vehicle control button, the motor vehicle comprising a vehicle control circuit and a walking system; the remote-controller being provided with at least one remote-controller control button, the remote-controller comprising a remote-controller circuit;

wherein the vehicle control circuit comprises at least a first wireless communication module, and the remote-controller circuit comprises at least a second wireless communication module; a wireless communication connection is established between the first wireless communication module and the second wireless communication module for transmitting remote control commands triggered by the remote-controller control button, and a positioning and ranging is also conducted between the first wireless communication module and the second wireless communication module.

In an embodiment, the first wireless communication module and the second wireless communication module are both UWB base station modules, and they are configured for UWB positioning and ranging by UWB positioning and ranging technology.

In an embodiment, the motor vehicle control system has a first control mode; and the first control mode is that:

when the motor vehicle is in a full brake state, and when the first vehicle control button on the motor vehicle is triggered by a first method, the motor vehicle is controlled to automatically move forward at a steady speed, and the UWB positioning and ranging of the first wireless communication module and the second wireless communication module are continuously enabled; once it is sensed that a distance between the remote-controller and the motor vehicle exceeds a set threshold value, the motor vehicle is controlled to brake and returns to the full brake state.

In an embodiment, the first control mode is an automatic walking mode, the first vehicle control button is an accelerate button on an armrest of the motor vehicle, and the first method is a short press.

In an embodiment, the motor vehicle control system further has a second control mode, and the second control mode is that:

when the motor vehicle is in the full brake state, and when the second vehicle control button on the motor vehicle is triggered by a second method, the motor vehicle is controlled to release the brake and is in a relaxed state; once it is detected that a third vehicle control button on the motor vehicle is triggered by a third method, then the motor vehicle is controlled to return to the full brake state.

In an embodiment, the second control mode is an easy push mode; the second vehicle control button is a decelerate button on the armrest of the motor vehicle, and the second method is a short press; the third vehicle control button is a boost button on the armrest of the motor vehicle, and the third method is a short press.

In an embodiment, the motor vehicle control system further has a third control mode, and the third control mode is that:

when the motor vehicle is in the full brake state, and when a fourth vehicle control button on the motor vehicle is triggered by a fourth method, the motor vehicle is controlled to run at a steady speed; once it is detected that a fifth vehicle button is triggered by a fifth method, the motor vehicle is controlled to move at a steady speed after increasing a speed of a gear; once it is detected that a sixth vehicle button is triggered by a sixth method, the motor vehicle is controlled to move at a steady speed after reducing the speed by a gear; once it is detected that a seventh vehicle control button on the motor vehicle is triggered by a seventh method, the motor vehicle is controlled to return to the full brake state.

In an embodiment, the third control mode is a boost mode;

the fourth vehicle control button is an boost button on the armrest of the motor vehicle, and the fourth method is a long press;

the fifth vehicle control button is an accelerate button on the armrest of the motor vehicle, the fifth method is a short press;

the sixth vehicle control button is an accelerate button on the armrest of the motor vehicle, the sixth method is a short press

the sixth vehicle control button is a decelerate button on the armrest of the motor vehicle, the sixth method is a short press;

the seventh vehicle control button is a boost button on the armrest of the motor vehicle, and the seventh method is to release.

It should be noted that the above-mentioned first vehicle control button, the second vehicle control button, . . . , the seventh vehicle control button may be implemented by corresponding to a plurality of different buttons on the armrest of the motor vehicle or by sharing the same button.

In an embodiment, the steady speed is based on PID control strategy.

In an embodiment, the walking system of the motor vehicle comprises a motor and a full-bridge motor drive module connected thereto; the motor vehicle running brake, full brake or move are realized by changing the PWM waveform corresponding to a power transistor loaded on the full-bridge motor drive module based on a PID control algorithm.

The present disclosure adopts the above technical solution to improve the vehicle control mode, such that the user can obtain a better customer experience.

### BRIEF DESCRIPTION OF DRAWINGS

FIG. 1 is a schematic diagram of a golf cart according to an embodiment of the present disclosure;

FIG. 2 is a schematic diagram of a remote-controller according to an embodiment of the present disclosure;

FIG. 3 is a circuit block diagram of a vehicle control circuit board according to an embodiment of the present disclosure;

FIG. 4 is a circuit block diagram of a main control drive board of the vehicle control circuit board in the present embodiment;

FIG. 5 is a schematic circuit diagram of a motor drive system according to an embodiment of the present disclosure;

FIG. 6 is a circuit block diagram of a UWB base station of the vehicle control circuit board in the present embodiment;

FIG. 7 is a circuit block diagram of a remote-controller circuit board of a remote-controller according to an embodiment of the present disclosure;

FIG. 8 is a schematic control flow diagram according to an embodiment of the present disclosure.

### DESCRIPTION OF EMBODIMENTS

To further illustrate the various embodiments, the present disclosure is provided with the accompanying drawings. These drawings are a part of the present disclosure, which are mainly used to illustrate the embodiments, and can be used in combination with the relevant description of the specification to explain the operation principles of the embodiments. With reference to these contents, one of ordinary skill in the art will understand other possible embodiments and advantages of the present disclosure. Components in the figures are not drawn to scale, and similar component references are often used to represent similar components.

The present disclosure will now be further described with reference to the accompanying drawings and specific embodiments.

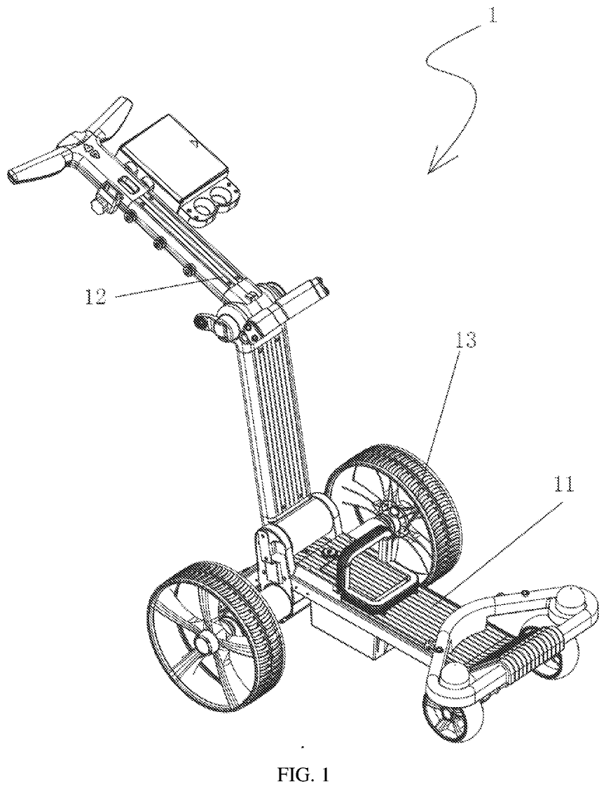

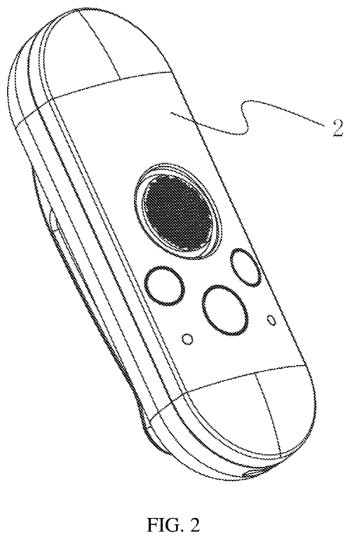

Referring to FIGS. 1 and 2, the motor vehicle control system of the present disclosure may include a motor vehicle 1 and a remote-controller 2, wherein the motor vehicle 1 may be described by taking a golf cart used in a golf course as an example, and the remote-controller 2 may be a UWB (Ultra Wideband) wireless remote-controller. The walking modes of the golf cart in the golf course may generally include: boost mode, remote control mode and follow mode. Among them, the boost mode refers to a way in which manpower assists the golf cart to travel.

Referring to FIG. 1 again, the motor vehicle 1 (golf cart) of the present embodiment may include a vehicle body 101, an armrest 102, a walking system 103 and a vehicle control circuit board 10. The armrest 102 may be provided with a plurality of control button, in the embodiment, it is described by taking three control buttons as an example, namely: an accelerate button, a decelerate button and a boost button. Among them, the walking system 103 is shown by taking a motor drive system as an example.

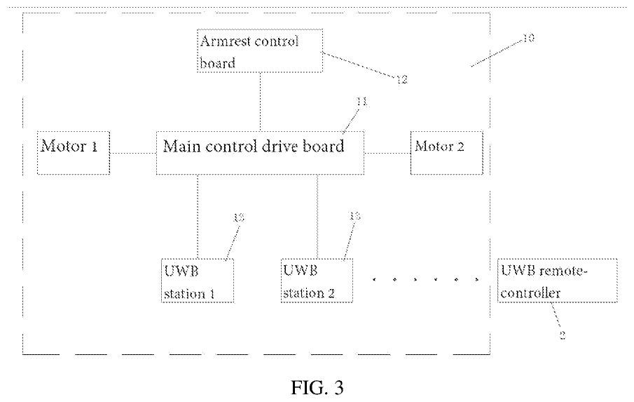

Referring to FIGS. 3 to 6, the vehicle control circuit board 10 may include a main control drive board 11, an armrest control board 12 and two UWB base stations 13. The armrest control board 12 may be mainly used to receive the inputs of control buttons, and in addition, the walking system 103 in the present embodiment may include two motors, the two motors are connected to the main control drive board 11. The main control drive board 11 realizes the overall main function control, including receiving the input signals of the two UWB base stations 13 and performing forward rotation, reverse rotation, short circuit, etc. of the motors to achieve travel (move) and braking control. In addition, based on other application requirements, the main control drive board 11 may also have other additional functions, such as detecting environmental gradients, collecting vehicle speed and so on.

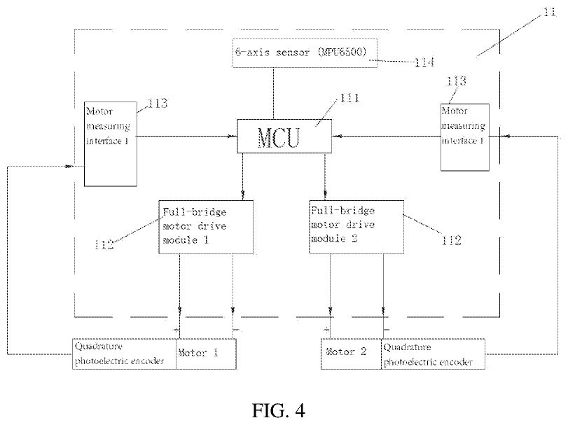

Referring to FIG. 4 again, the main control drive board 11 may include a microprocessor module (MCU) 111, two full-bridge motor drive modules 112, two motor speed measuring interfaces 113, and a six-axis sensor (MPU6500) module 114 connected to the MCU 111. The golf cart in the present embodiment may also have the function of measuring the speed of the motor. In the present embodiment, the photoelectric coding is used for counting to realize the speed measurement of the motor (in other embodiments, a Hall sensor can also be used), so that the current vehicle speed can be converted by the microprocessor module 111 after received by the motor measuring interfaces 113. In addition, the golf cart of the present disclosure may also have a function for detecting the pitch angle. The pitch angle detected by the MPU6500 six-axis angular velocity and angular acceleration sensors is the slope of the environment where the golf cart is located at this time. The detected pitch angle can be used as the control input variable to participate in the vehicle speed control adjustment.

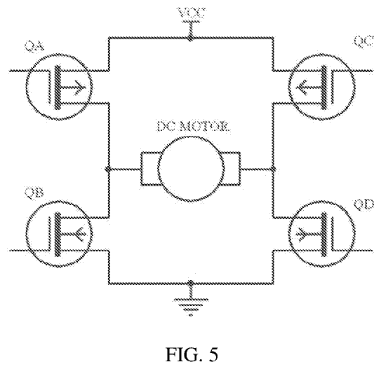

Referring again to FIG. 5, the walking drive and speed control of the golf cart in the present embodiment are controlled by a single DC motor in a full-bridge driving manner. Shown in the figure is the specific circuit of the full-bridge motor drive module 112 of a preferred embodiment of the golf cart according to the present disclosure, which includes a single-motor full-bridge drive circuit composed of four power transistors QA, QB, QC, and QD. When the power transistors QA and QD are conducted, the motor DC MOTOR rotates forward, and when the power transistors QB and QC are conducted, the motor DC MOTOR reverses. Therefore, as long as a certain PWM (Pulse Width Modulation) waveform is used to control the conduction of the power transistors QA and QD or control the conduction of the power transistors QB and QC by adjusting the duty cycle, the speed control of the motor DC MOTOR can be realized. When the power transistors QB and QD are conducted, both ends of the motor DC MOTOR are shorted to ground. As long as the external force rotates the motor DC MOTOR, there will be electromotive force at both ends of the motor DC MOTOR, and a short-circuit current will be generated. This current is just opposite to the rotation direction of the motor, which will form resistance. At this time, the motor DC MOTOR has braking force. At this time, the motor DC MOTOR can still be rotated by applying enough external force, but there will be a lot of resistance. Therefore, if we use a certain PWM (Pulse Width Modulation) waveform to control the conduction of the power transistors QB and QD by adjusting the duty cycle to short-circuit the motor, there will be an adjustment of control for the braking depth (change of braking force). For example, a PWM waveform with a 10% duty cycle is short-circuited. At this time, the braking resistance of the motor is relatively small. When gradually increasing the duty cycle of the PWM waveform, the braking resistance will gradually increase until the power transistors QB and QD are fully conducted to achieve a complete short-circuit of the motor, such that the maximum braking resistance can be achieved.

In the present embodiment, the main control drive board 11 performs the steady speed control and the braking control by preferably using the PID control algorithm, and the PID control algorithm is based on the proportional-integral-derivative (PID) control strategy to adjust the PWM waveforms of the corresponding power transistors QA, QB, QC, QD to achieve stable braking and steady speed control. For example, in the present embodiment, the control of stable braking is to adjust and change the PWM waveforms loaded on the power transistors QB and QD to change the braking resistance of the motor, thereby realizing braking stabilization; the PWM waveforms on the switch tubes QA, QD (forward rotation) and/or the power transistors QB, QC (reverse rotation) can change the speed of the motor, so as to achieve steady speed of the vehicle. Among them, the change amount of PWM waveform is realized based on PID control strategy. The PID control strategy to realize the PWM waveform adjustment is a technology that can be mastered by those skilled in the art, and will not be described in detail here. It should be noted that, in addition to the PID control strategy, other control strategies, such as fuzzy control strategy, FPS control strategy, ADRC control strategy, etc., may also be adopted for adjustment control in the application of other embodiments.

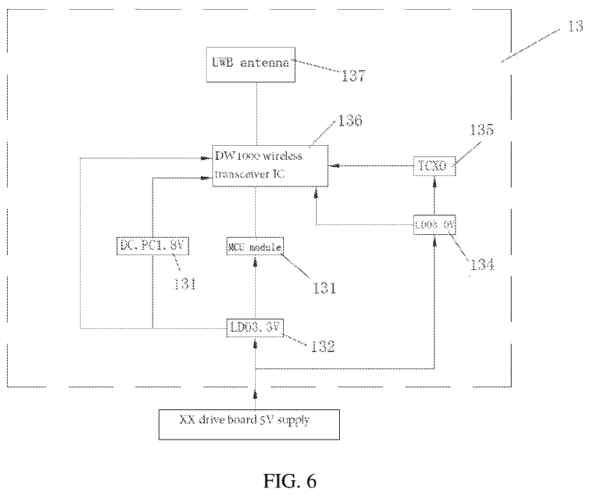

Referring again to FIG. 6, in the present embodiment, the UWB base station 13 may include: an MCU main control module 131, a 3.3V low dropout regulator LDO (low dropout regulator) module 132, a 1.8V DC-DC (DC to DC, Direct Current to Direct Current) buck module 133, a 3.0V low dropout regulator LDO module 134, a temperature compensate X'tal (crystal) oscillator TCXO module 135, a UWB wireless transceiver module (UWB chip of the DW1000 model) 136 and a UWB antenna 137. Among them, the 3.3V low dropout regulator LDO module 132 may be used to convert the 5V power supply of the main control drive board 11 into DC 3.3V, and the 1.8V DC-DC buck module 133 may be used to convert the 3.3V low dropout linear regulator LDO module 132 to step down to DC 1.8V, the 3.0V low dropout linear regulator LDO module 134 may be used to convert the 5V power supply of the main control drive board 11 to DC 3.0V. The MCU main control module 131 accepts the DC 3.3V of the 3.3V low dropout linear regulator LDO module 132 as a working power supply, the MCU main control module 131 may be used to control the UWB wireless transceiver module 136 to work, and the temperature compensate crystal oscillator TCXO module 135 accepts the DC 3.0V of the 3.0V low dropout linear regulator LDO module 134 as a working power supply, and the temperature compensate crystal oscillator TCXO module 135 provides an oscillation source for the UWB wireless transceiver module 136. The UWB wireless transceiver module 136 accepts the DC 3.3V of the 3.3V low dropout linear regulator LDO module 132, the DC 1.8V of the 1.8V DC-DC buck module 133 and the DC 3.0V of the low dropout linear regulator LDO module 134 as the working power supply.

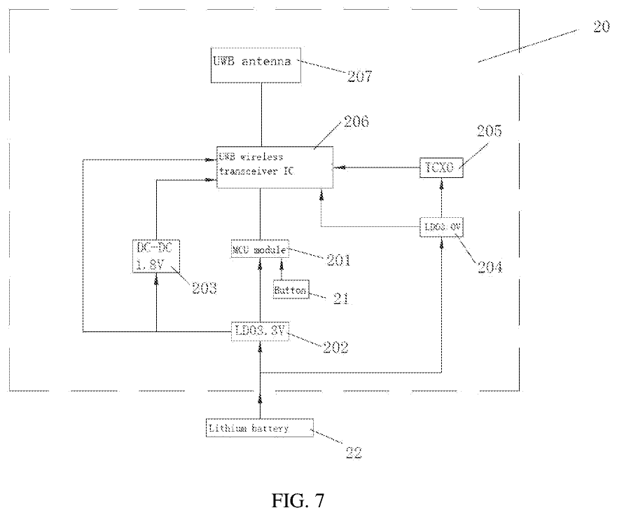

Referring to FIG. 7, in the present embodiment, the remote-controller 2 may include: a remote-controller circuit board 20, buttons 21 and a lithium battery 22. The lithium battery 22 can be a lithium polymer battery. Wherein the remote-controller circuit board 20 may include: an MCU main control module 201, a 3.3V low dropout regulator LDO module 202, a 1.8V DC-DC (Direct Current to Direct Current) buck module 203, a 3.0V low dropout linear regulator LDO module 204, a temperature compensate X'tal (crystal) oscillator TCXO module 205, a UWB wireless transceiver module (UWB chip of the DW1000 model) 206 and a UWB antenna 207. Among them, the 3.3V low dropout linear regulator LDO module 202 can be used to convert the voltage of the lithium battery 22 into DC 3.3V, the 1.8V DC-DC buck module 203 may be used to linearly stabilize the 3.3V low dropout regulator LDO module 202 to step down to DC 1.8V, the 3.0V low dropout linear regulator LDO module 204 may be used to convert the 5V power supply of the main control drive board 11 to DC 3.0V, and the MCU main control module 201 accepts the DC 3.3V of the 3.3V low dropout linear regulator LDO module 202 as the working power supply. The MCU main control module 201 may be used to control the UWB wireless transceiver module 206 to work, and to accept the input commands of the buttons 21, the temperature compensate crystal oscillator TCXO module 205 accepts the DC 3.0V of the 3.0V low dropout linear regulator LDO module 204 as a working power supply, and the temperature compensate crystal oscillator TCXO module 205 may provide an oscillation source for the UWB wireless transceiver module 206. The UWB wireless transceiver module 206 accepts the DC 3.3V of the 3.3V low dropout linear regulator LDO module 202, the DC 1.8V of the 1.8V DC-DC buck module 203 and the DC 3.0V of the 3.0V low dropout linear regulator LDO module 204 as the working power supply.

In the embodiment of the present disclosure, the remote-controller 2 can transmit the remote control commands of the buttons to the vehicle control circuit board 10 of the motor vehicle 1 through the buttons 21 and the UWB wireless transceiver module 206 on the remote-controller circuit board 20. The vehicle control circuit board 10 receives the remote control commands through the UWB base station 13, and is controlled by the main control drive board 11 to realize the functions corresponding to the commands. In addition, the UWB wireless transceiver module 206 on the remote-controller circuit board 20 of the remote-controller 2 and (the UWB wireless transceiver module 136 of) UWB base station 13 on the vehicle control circuit board 10 of the motor vehicle 1 can be positioned to sense the distance between the remote-controller 2 and the motor vehicle 1. UWB positioning and ranging technology is a positioning technology realized by broadband pulse communication technology, which has the technical advantages of strong anti-interference ability and small positioning error (usually less than 10 cm). UWB positioning and ranging technology is an existing technology that can be mastered by those skilled in the art, and will not be described in detail herein.

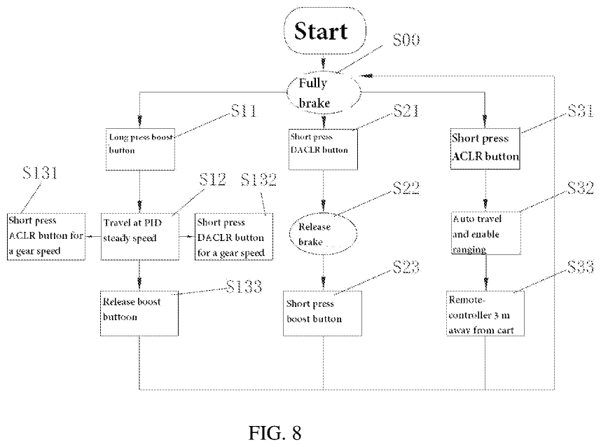

Referring to FIG. 8, the control flow in an embodiment of the present disclosure is shown as follows, including:

(1) The implementation process of the boost mode:

The implementation process of the boost mode is implemented similarly to the boost mode of the golf cart in the prior art, and specifically includes:

S11: when the vehicle is in a full brake state, when the user presses the boost button fora long time;

S12: the vehicle travels at a steady speed controlled by PID;

When S131: short press the accelerate (ACLR) button, after the vehicle increases the speed by a gear, it will travel at a steady speed controlled by PID;

When S132: short press the decelerate (DACLR) button, after the vehicle decreases the speed by a gear, it will travel at a steady speed controlled by PID;

When S133: release the boost button, return to

S00: the vehicle is in a full brake state.

(2) The implementation process of the easy push mode:

The easy push mode is to solve the problem of the golf cart in the prior art that the vehicle is fully braked in a stopped state and cannot be pushed by a person, and the vehicle can only be operated in the boost mode only through the control buttons on the armrest of the vehicle. The single control method leads to the possibility of using the boost button to control the possibility of danger when the booster action is in a dangerous area or a short-distance situation. Therefore, the easy push mode can release the brake state of the vehicle in a stopped state, so that the vehicle does not have a braking force, but can be easily pushed by manpower alone without the aid of the propulsion force. The easy push mode can be well applied in some applications, making up for the deficiencies of the existing technology. Specifically, the easy push mode may include:

S21: when the vehicle is in a full brake state, after the user short presses the decelerate button;

S22: the vehicle releases the brake and is in a relaxed state;

When S23: short press the boost button, it will return to

S00: the vehicle is in the full brake state.

(3) The implementation process of automatic walking mode:

The automatic walking mode is to solve the problem of hand fatigue caused by the golf cart in the prior art requiring the user to press the boost mode for a long time. At the same time, the present disclosure also introduces a protection mechanism in the automatic walking mode. At the same time, the convenience of automatic walking also avoids the occurrence of danger to the greatest extent. Specifically, the automatic walking mode may include:

S31: when the vehicle is in the full brake state, after the user short presses the accelerate button;

S32: the vehicle is controlled to automatically move forward at a steady speed and continuously enable UWB positioning and ranging;

When S33: once it is sensed that the distance between the remote-controller 2 and the motor vehicle 1 exceeds a set threshold, such as 3 meters, return to

S00: the vehicle is in the full brake state.

It should be noted that the golf cart of the embodiment of the present disclosure has the control flow of the above three modes, but in the application of other embodiments, any one or any two groups of the above three modes can also be selected for combination. In addition, the golf cart according to the embodiment of the present disclosure also has other control modes, such as remote control of walking through a remote-controller, just like the existing golf cart.

In the present embodiment of the present disclosure, the armrest 102 of the motor vehicle 1 may be provided with three control buttons, namely: boost button, accelerate button, and decelerate button, and the remote-controller 2 and the motor vehicle 1 can use the UWB positioning and ranging function for detecting the distance between the vehicle and the remote-controller in real time. When the remote-controller 2 is not connected (the remote-controller is turned off, or is not within the communication distance), the user keeps pressing the boost button on the armrest 102 to travel at the first speed, and then stops slowly when released, and finally brakes completely. When moving forward, the speed of the vehicle can be controlled by pressing the accelerate button and the decelerate button on the armrest 102 respectively. When the vehicle is in the stop mode, it is in a full brake state, in this state, the vehicle is very difficult to push. The decelerate button is pressed to enter the easy push mode. At this time, the vehicle control system releases the brake on the motor, which is equivalent to the vehicle being in neutral. At this time, it is very convenient to push the turn by hand. The boost button is short pressed again to enter the brake state. For example, if the vehicle wants to stop on a slope, this mode needs to be adopted to operate. In addition, in the present embodiment, when the remote-controller 2 has a wireless communication connection with the motor vehicle 1, a safety protection function is added. In the stop mode, the accelerate button is short pressed, the vehicle will install the setting of the automatic walking mode and keep moving forward. At this time, the motor vehicle 1 and the remote-controller 2 continue to perform positioning and ranging. Once it is sensed that the distance between the them exceeds 3 m, the motor vehicle 1 brakes to stop. It can be expected that if there is no ranging function in the automatic walking mode, it is assumed that the vehicle keeps moving forward. If the user does not keep up and the vehicle cannot stop, there will be dangers. For example, there is a lake in front. The vehicle would fall into the lake, or worse, hit people and objects in the distance. Therefore, the present embodiment of the present disclosure innovatively adds the automatic walking mode and the ranging function in this mode, which can be used to ensure safety, so that the user does not need to use the operation in the existing boost mode all the time, and the boost button can be pressed and held. In the automatic walking mode, the user only needs to walk behind the vehicle, and there is no need to worry about poor exercise performance due to hand fatigue. It is a safe and labor-saving convenient operation mode.

Although the present disclosure has been particularly shown and described in connection with preferred embodiments, it will be understood by those skilled in the art that various changes in form and detail made to the present disclosure without departing from the spirit and scope of the present disclosure as defined by the appended claims fall within the protection scope of the present disclosure.

1. A motor vehicle control system, comprising a motor vehicle and a remote-controller; the motor vehicle being provided with at least a first vehicle control button, a second vehicle control button, and a third vehicle control button, the motor vehicle comprising a vehicle control circuit and a walking system; the remote-controller being provided with at least one remote-controller control button, the remote-controller comprising a remote-controller circuit; wherein:
the vehicle control circuit comprises at least a first wireless communication module,
the remote-controller circuit comprises at least a second wireless communication module,
a wireless communication connection is established between the first wireless communication module and the second wireless communication module for transmitting remote control commands triggered by the remote-controller control button,
a positioning and ranging is also conducted between the first wireless communication module and the second wireless communication module,
the motor vehicle control system has a first control mode,
the first control mode provides that:
when the motor vehicle is in a full brake state and when the first vehicle control button on the motor vehicle is triggered by a first method, the motor vehicle is controlled to automatically move forward at a steady speed and the positioning and ranging of the first wireless communication module and the second wireless communication module are continuously enabled; once it is sensed that a distance between the remote-controller and the motor vehicle exceeds a set threshold value, the motor vehicle is controlled to brake and returns to the full brake state; and
the motor vehicle control system further has a second control mode,
the second control mode provides that:
when the motor vehicle is in the full brake state and when the second vehicle control button on the motor vehicle is triggered by a second method, the motor vehicle is controlled to release a brake and is in a relaxed state; once it is detected that the third vehicle control button on the motor vehicle is triggered by a third method, the motor vehicle is controlled to return to the full brake state.

2. The motor vehicle control system according to claim 1, wherein:
the first wireless communication module and the second wireless communication module are both ultra wideband (UWB) base station modules, and
the first wireless communication module and the second wireless communication module are configured for the positioning and ranging by UWB positioning and ranging technology.

3. (canceled)

4. The motor vehicle control system according to claim 1, wherein:
the first control mode is an automatic walking mode,
the first vehicle control button is an accelerate button on an armrest of the motor vehicle, and
the first method is a short press.

5. (canceled)

6. The motor vehicle control system according to claim 1, wherein:
the second control mode is push mode,
the second vehicle control button is a decelerate button on an armrest of the motor vehicle,
the second method is a short press,
the third vehicle control button is a boost button on the armrest of the motor vehicle, and
the third method is a short press.

7. The motor vehicle control system according to claim 1, wherein:
the motor vehicle control system further has a third control mode, and
the third control mode provides that:
when the motor vehicle is in the full brake state and when a fourth vehicle control button on the motor vehicle is triggered by a fourth method, the motor vehicle is controlled to run at the steady speed; once it is detected that a fifth vehicle control button on the motor vehicle is triggered by a fifth method, the motor vehicle is controlled to move at the steady speed after increasing a speed of a gear; once it is detected that a sixth vehicle control button on the motor vehicle is triggered by a sixth method, the motor vehicle is controlled to move at the steady speed after reducing the speed by the gear; once it is detected that a seventh vehicle control button on the motor vehicle is triggered by a seventh method, the motor vehicle is controlled to return to the full brake state.

8. The motor vehicle control system according to claim 7, wherein:
the third control mode is a boost mode,
the fourth vehicle control button is a boost button on an armrest of the motor vehicle,
the fourth method is a long press,
the fifth vehicle control button is an accelerate button on the armrest of the motor vehicle,
the fifth method is a short press,
the sixth vehicle control button is a second accelerate button on the armrest of the motor vehicle,
the sixth vehicle control button is a decelerate button on the armrest of the motor vehicle,
the sixth method is a short press,
the seventh vehicle control button is a second boost button on the armrest of the motor vehicle, and
the seventh method is to release.

9. The motor vehicle control system according to claim 7, wherein the steady speed is based on a proportional-integral-derivative (PID) control strategy.

10. The motor vehicle control system according to claim 9, wherein:
the walking system of the motor vehicle comprises a motor and a full-bridge motor drive module connected to the motor,
the motor vehicle running brake, full brake or move are realized by changing a pulse width modulation (PWM) waveform corresponding to a power transistor loaded on the full-bridge motor drive module based on a PID control algorithm.
